(19) United States
(12) Patent Application Publication
(10) Pub. No.: US 2026/0360348 A1
(43) Pub. Date: Nov. 12, 2026

(54) ACTIVE NOISE CANCELLATION FOR VEHICLE CABIN

(71) Applicant: GM GLOBAL TECHNOLOGY OPERATIONS LLC, Detroit, MI (US)

(72) Inventors: Hyukjin Oh, Incheon (KR); Sukhyun An, Seo-gu (KR); Bongbum Back, Incheon (KR)

(73) Assignee: GM GLOBAL TECHNOLOGY OPERATIONS LLC, Detroit, MI (US)

(21) Appl. No.: 19/202,334

(22) Filed: May 8, 2025

(51) Int. Cl. G10K 11/178

(52) U.S. Cl. CPC G10K 11/17881; G10K 11/17857; G10K 2210/124; G10K 2210/1282; G10K 2210/3026; G10K 2210/50

(57) ABSTRACT

An active noise cancellation system including a microphone array configured to receive an audio signal and a residual noise, a signal processor configured to determine a gain vector in response to an amplitude, a frequency and a phase of the audio signal, to generate a first destructive audio signal in response to the gain vector and the audio signal, and to couple the first destructive audio signal to a plurality of speakers within a vehicle cabin configured to radiate the first destructive audio signal into the vehicle cabin, the signal processor being further operative to generate a filter coefficient in response to the residual noise to generate a second destructive audio to radiate into the vehicle cabin.

### BACKGROUND

The present disclosure relates generally to programming motor vehicle audio and sound suppression systems. M ore specifically, aspects of this disclosure relate to systems, methods and devices for robust noise detection and cancelling undesired noise sources within predetermined vehicle cabin zones.

Active noise cancellation (ANC) in a vehicle cabin significantly enhances the driving and passenger experience by creating a more serene and comfortable environment. By utilizing microphones to detect unwanted noises like engine hum, road vibrations, and wind noise, and then generating opposing sound waves to neutralize them, ANC effectively reduces these disturbances. This results in a quieter cabin, which not only lessens driver fatigue and stress during long journeys but also improves communication clarity and enhances the enjoyment of in-car entertainment. Furthermore, by reducing the reliance on traditional, heavy sound-dampening materials, ANC can contribute to improved fuel efficiency and electric vehicle range.

ANC in a vehicle cabin can be particularly beneficial for parents traveling with sleeping infants by effectively minimizing the disruptive impact of external sounds, particularly honking horns. The ability to identify and neutralize sudden, sharp noises like horns prevents those jarring sounds from penetrating the cabin and disturbing a baby's delicate sleep. By creating a more consistent and peaceful auditory environment, ANC allows the baby to remain undisturbed, reducing parental stress and promoting a more restful journey for both the child and caregivers. This feature reduces the ambient and sudden noise levels in the vehicle cabin, ensuring that even in bustling urban environments, a sleeping baby can remain undisturbed. It is desirable to address these problems to provide improved ANC in a vehicle cabin application. The above information disclosed in this background section is only for enhancement of understanding of the background of the invention and therefore it may contain information that does not form the prior art that is already known in this country to a person of ordinary skill in the art.

### SUMMARY

Disclosed herein are vehicle communications systems, vehicle user interface systems and related control logic for provisioning vehicle user interface systems, methods for making and methods for operating such systems, and motor vehicles equipped with user interface systems. By way of example, and not limitation, there is presented a system for active noise cancellation in a vehicle cabin configured to detect a vehicle horn, to generate a destructive audio signal in response to the detected vehicle horn audio, to detect a residual noise within the vehicle cabin at a seating location, and to generate a second destructive audio signal in response to the first destructive audio signal and the residual noise.

In accordance with an aspect of the present disclosure, an active noise cancellation system including a microphone array configured to receive an audio signal and a residual noise, a signal processor configured to determine a gain vector in response to an amplitude, a frequency and a phase of the audio signal, to generate a first destructive audio signal in response to the gain vector and the audio signal, and to couple the first destructive audio signal to a plurality of speakers within a vehicle cabin, and the plurality of speakers configured to radiate the first destructive audio signal into the vehicle cabin, the signal processor being further operative to generate a filter coefficient in response to the residual noise, wherein the residual noise results from a combination of the audio signal and the first destructive audio signal within the vehicle cabin, to generate a second destructive audio signal in response to the filter coefficient and the first destructive audio signal, and to couple the second destructive audio signal to the plurality of speakers, wherein the plurality of speakers are configured to radiate the second destructive audio signal into the vehicle cabin.

In accordance with another aspect of the present disclosure wherein the microphone array includes a plurality of microphones distributed throughout a vehicle passenger cabin.

In accordance with another aspect of the present disclosure wherein the audio signal is generated by a vehicle horn and wherein an active noise cancellation algorithm is activated in response to a depression of a vehicle horn button.

In accordance with another aspect of the present disclosure wherein the signal processor is further configured for determining a seating occupancy at a seating location and wherein the first destructive audio signal is generated to attenuate the audio signal at the seating location and to enhance the audio signal at a driver seating location.

In accordance with another aspect of the present disclosure wherein the signal processor is further configured for detecting a child restrain device in a seating location and wherein the first destructive audio signal is generated to attenuate the audio signal at the seating location.

In accordance with another aspect of the present disclosure wherein the signal processor is further configured for updating a covariance matrix in response to the filter coefficient and the residual noise and generating the second destructive audio signal in response to the covariance matrix.

In accordance with another aspect of the present disclosure wherein the microphone array is located outside of the vehicle cabin and wherein the audio signal originates from another vehicle.

In accordance with another aspect of the present disclosure wherein the microphone array is distributed throughout the vehicle cabin and wherein a residual noise phase and a residual noise amplitude are determined in response to a plurality of representations of the residual noise received at the microphone array and wherein the filter coefficient is generated in response to the residual noise phase and the residual noise amplitude.

In accordance with another aspect of the present disclosure wherein the microphone array is located within the vehicle cabin and wherein the audio signal originates from a horn of a host vehicle.

In accordance with another aspect of the present disclosure, a method for performing active noise cancellation within a vehicle cabin including receiving, via a microphone array, an incoming acoustic signal including an audio signal, determining, by a processor, a gain vector in response to an amplitude, a frequency and a phase of the audio signal, generating, by a communications processor, a first destructive audio signal in response to the gain vector, coupling the first destructive audio signal to a plurality of speakers located within the vehicle cabin, detecting, with a microphone within the vehicle cabin, a residual noise, wherein the residual noise results from a combination of the audio signal and the first destructive audio signal within the vehicle cabin, generating, by the processor, a filter coefficient in response to the residual noise, and generating, by the communications processor, a second destructive audio signal in response to the filter coefficient and the first destructive audio signal, and coupling the second destructive audio signal to the plurality of speakers located within the vehicle cabin.

In accordance with another aspect of the present disclosure wherein the microphone array includes a plurality of microphones within a vehicle passenger cabin.

In accordance with another aspect of the present disclosure wherein the audio signal is generated by a vehicle horn and wherein an active noise cancellation algorithm is activated in response to a depression of a vehicle horn button.

In accordance with another aspect of the present disclosure including determining a seating occupancy at a seating location and wherein the first destructive audio signal is generated to attenuate the audio signal at the seating location and to enhance the audio signal at a driver seating location.

In accordance with another aspect of the present disclosure including detecting a child restrain device installed in a seating location and wherein the first destructive audio signal is generated to attenuate the audio signal at the seating location.

In accordance with another aspect of the present disclosure including updating a covariance matrix in response to the filter coefficient and the residual noise and generating the second destructive audio signal in response to the covariance matrix.

In accordance with another aspect of the present disclosure wherein the microphone array is mechanically coupled to a host vehicle outside of the vehicle cabin and wherein the first destructive audio signal originates from another vehicle.

In accordance with another aspect of the present disclosure wherein the microphone within the vehicle cabin includes a plurality of microphones distributed throughout the vehicle cabin and wherein a residual noise phase and a residual noise amplitude are determined in response to a plurality of representations of the residual noise received at the microphone array and wherein the filter coefficient is generated in response to the residual noise phase and the residual noise amplitude.

In accordance with another aspect of the present disclosure the microphone array is located within the vehicle cabin and wherein the first destructive audio signal originates from a horn of a host vehicle.

In accordance with another aspect of the present disclosure, an active noise cancellation system within a vehicle cabin including a first plurality of microphones located within the vehicle cabin for receiving an acoustic signal and for generating a first data representative of the acoustic signal received at the first plurality of microphones, wherein the first data is representative of a first gain, a first phase and a first amplitude of the acoustic signal received at the first plurality of microphones, a second plurality of microphones located external to the vehicle cabin for generating a second data representative of the acoustic signal received at the second plurality of microphones, wherein the second data is representative of a second gain, a second phase, and a second amplitude of the acoustic signal received at the second plurality of microphones, a processor for determining a gain vector in response to the first phase, the second phase, the first amplitude, and the second amplitude, for determining generating a destructive audio signal in response to the gain vector, a communications processor for coupling the destructive audio signal to a plurality of speakers within the vehicle cabin such that the acoustic signal is attenuated within the vehicle cabin.

In accordance with another aspect of the present disclosure including a user interface operative to receive a user input and wherein an active noise cancellation algorithm is initiated in response to the user input, and a seating occupancy sensor configured to detect an occupant in a seating location, and wherein the communications processor is further operative to focus the destructive audio signal at the seating location such that the acoustic signal is attenuated at the seating location and the acoustic signal is not attenuated at a driver seating location

The exemplifications set out herein illustrate preferred embodiments of the invention, and such exemplifications are not to be construed as limiting the scope of the invention in any manner.

### BRIEF DESCRIPTION OF THE DRAWINGS

The exemplary embodiments will hereinafter be described in conjunction with the following drawing figures, wherein like numerals denote like elements, and wherein:

FIG. 1 is illustrative of an operating environment for providing cancellation techniques for acoustic interference cancellation in a bidirectional vehicle communications system in accordance with various embodiments;

FIG. 2 shows a flow chart illustrating an exemplary implementation of a method for providing cancellation techniques for acoustic interference cancellation in a bidirectional vehicle communications system in accordance with various embodiments;

FIG. 3 shows a flow chart illustrating an exemplary implementation of a method for providing cancellation techniques for acoustic interference cancellation in a bidirectional vehicle communications system in accordance with various embodiments; and

FIG. 4 shows a block diagram illustrating another exemplary implementation of an active noise cancellation system in accordance with various embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Implementing active noise cancellation (ANC) within a vehicle cabin to mitigate external sound disturbances for vehicle occupants can employ a targeted approach. For example, utilizing a distributed microphone array strategically placed within the cabin, we can accurately capture the frequency and amplitude of the audible signal. A real-time digital signal processor (DSP) can then be used to generate an anti-phase signal, optimized for the specific frequency range associated with typical horn sounds, and outputs it through the vehicle's audio system. This effectively creates destructive interference, minimizing the horn's audibility within the cabin. The system's adaptive algorithms must account for the dynamic nature of the vehicle's environment and the variability of horn sound characteristics to ensure robust and consistent noise reduction, thereby preserving the infant's sleep.

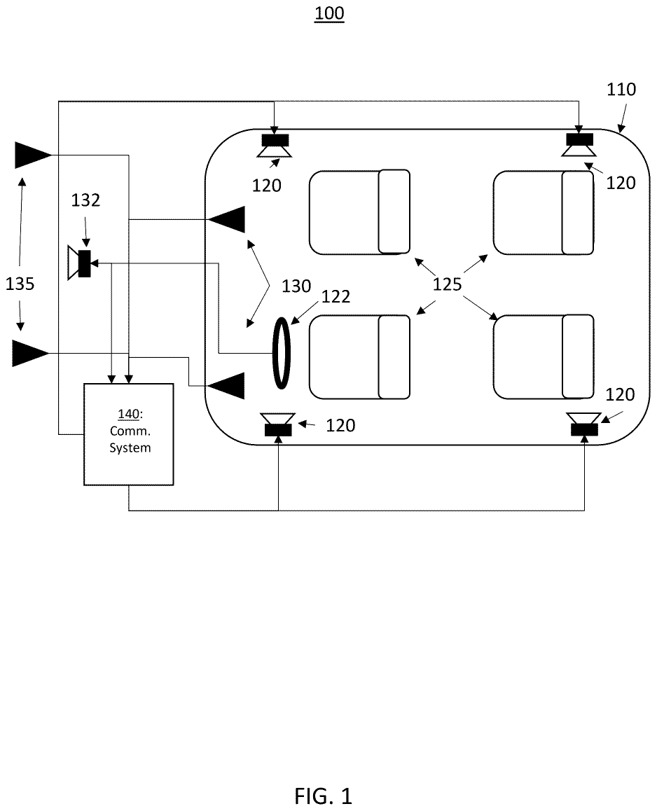

FIG. 1 shows an operating environment 100 for providing cancellation techniques for acoustic interference cancellation in a bidirectional vehicle communications system according to an exemplary embodiment. The exemplary environment 100 shows a vehicle cabin 110 with a plurality of speakers 120 and a plurality of interior microphones 130 and a plurality of external microphones 135 coupled to a communications system 140. Within the vehicle cabin 110 there are also a plurality of vehicle occupant seating positions 125. Typically, in a vehicle cabin hands free communication system, each of the plurality of speakers 120 may be configured to receive an incoming portion of an audio conversation from a communications system 140 and to broadcast the incoming portion within the vehicle cabin 110. Each of the plurality of microphones within the microphone array 130 is operative to receive an outgoing portion of an audio conversation and to transmit this outgoing portion to the communications system 140 for transmission via a wireless network, such as a cellular telephone network or the like.

In a first exemplary embodiment, the communications system 140, or other capable controller, equipped with an array of strategically placed interior microphones 130 within the vehicle cabin 110, can initiate an active noise cancellation (ANC) process by continuously monitoring the ambient soundscape. When a vehicle horn 132 is activated in response to a horn button push on the steering wheel 122 or the like, the microphones 130 can detect the sudden, high-amplitude, and transient sound wave. Interior microphones 130, typically condenser or MEMS types, possess the sensitivity and bandwidth required to capture the rapid frequency variations characteristic of a horn. The communications controller 140 can then analyzes the captured audio from the horn, employing algorithms such as Fast Fourier Transform (FFT) or adaptive filtering techniques, to isolate the horn's frequency components and determine its amplitude and phase. This real-time analysis enables the system to rapidly characterize the unwanted noise, preparing for the generation of the cancellation signal.

Following the analysis, the communications system 140 can generate an anti-phase signal that precisely mirrors the detected horn sound wave. This cancellation signal, with an inverted phase, is then routed to the vehicle's audio speakers 120. The speakers, acting as actuators, reproduce the anti-phase signal, which effectively interferes destructively with the incoming horn noise. This destructive interference, achieved by superimposing the original sound wave with its inverse, results in a significant reduction of the horn's audible presence within the cabin. Adaptive algorithms can be employed to continuously refine the cancellation signal based on real-time feedback from the microphones 130, ensuring optimal noise reduction even as the horn's characteristics or the cabin's acoustic environment changes. This feedback loop allows for dynamic adjustments, maintaining a quiet and comfortable cabin environment despite external noise variations.

Similar, the exterior microphones 135 can be employed with the ANC system, utilizing cabin-mounted microphones 130 and the communications system 140, to effectively mitigate horn sounds from other vehicles and diverse undesirable noises by employing a similar methodology. Upon detecting the incoming sound wave, regardless of its source, the exterior microphones 135 can capture the acoustic information, which is then analyzed by the communications system 140. Employing algorithms like adaptive filtering and frequency domain analysis, the communications system 140 isolates the unwanted noise's characteristics, including its frequency, amplitude, and phase. Subsequently, the communications system 140 generates an anti-phase signal that mirrors the detected noise, and this signal is played through the vehicle's speakers 120. This destructive interference cancels out the incoming noise waves, regardless of their origin, effectively reducing their audibility within the cabin. The ANC system's adaptive nature allows it to dynamically adjust the cancellation signal in response to varying noise characteristics detected by the internal microphones 130, ensuring consistent and effective noise reduction for a wide range of external disturbances.

In addition, selective sound cancellation, targeting specific seating locations while excluding the driver's area, can be achieved through beamforming and zone control techniques. The communications system 140 can employ multiple microphones strategically positioned throughout the cabin, or feedback signals from the plurality of speakers 120, enabling precise spatial sound field analysis. By utilizing algorithms that calculate the time delays and amplitude differences of the incoming sound waves at each microphone 130, 135, the communications system 140 can determine the sound source's location and direction. This allows the communications system 140 to generate tailored anti-phase signals for specific zones, such as rear passenger seats or a baby's car seat, while simultaneously minimizing the cancellation effect at the driver's location. This selective cancellation is accomplished by adjusting the phase and amplitude of the cancellation signals sent to individual speakers 120, creating constructive interference at the driver's location, thus preserving audibility, and destructive interference at the targeted seating locations. This precise control over the sound field allows for a customized auditory experience, ensuring a quiet environment for passengers without compromising the driver's awareness of essential auditory cues.

It should be appreciated that the illustrated embodiment has been simplified for ease of understanding, and that the bidirectional communications system 100 may include additional devices, processing modules, and elements that support additional features and functions that need not be described in detail here. Likewise, those skilled in the art will recognize that an embodiment of the vehicle cabin 110 will include many conventional features, subsystems, and components that are commonly found in modern vehicles. Such conventional aspects of the vehicle cabin 110 will not be described here.

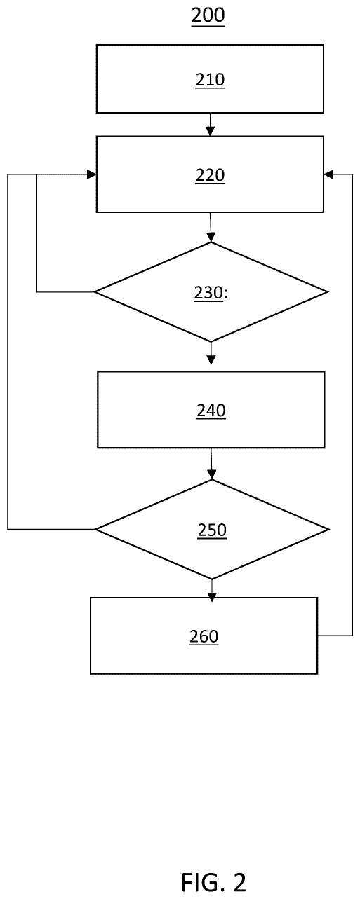

Turning now to FIG. 2, a flow chart illustrating an exemplary implementation of a method 200 for providing cancellation techniques for acoustic interference cancellation in a bidirectional vehicle communications system according to an exemplary embodiment. This method 200 leverages the principle of destructive interference to attenuate the horn sound within the car's cabin. The method 20 is configured to generate an anti-phase signal of the same frequency. This anti-phase signal, when superimposed onto the incoming horn sound wave, results in cancellation due to the opposing peaks and troughs. Implementation involves a microphone placed within the cabin to detect the horn sound, followed by signal processing to invert the phase and amplify it. This inverted signal is then played through speakers strategically positioned within the cabin, effectively reducing the perceived loudness of the horn.

The exemplary method 200 is operative to initiate 210 the active noise cancellation (ANC) algorithm. The ANC can be initiated 210 in response to a user input on a user interface, such as a touch screen display on a vehicle infotainment system. Upon user selection of the ANC feature via a touch screen display on the infotainment system, a signal is sent to the vehicle's central processing unit or dedicated ANC control module. This signal generated in response to the user input can activate the ANC algorithm, initiating the real-time analysis and cancellation of ambient noise. A digital signal processor (DSP) or other processor or microcontroller can be used to execute the A N C algorithm. The user interface can be further enhanced to allow for zonal ANC, where specific seating locations can be targeted for noise reduction. For instance, selecting a seating location with a child restraint device triggers the ANC algorithm to prioritize noise cancellation at that specific zone. This is achieved by adjusting the gain and filter parameters of the ANC algorithm, focusing the anti-phase signal generation towards the speakers closest to the selected seat. Simultaneously, the algorithm may employ a spatial filter to minimize the impact of the cancellation signal on other areas of the cabin, ensuring a focused and effective noise reduction experience for the selected passenger.

The method 200 is next operative to monitor 220 for the targeted noise frequency, such as a vehicle horn. In some exemplary embodiments, microphones located in the vehicle cabin, such as near the driver and passenger headrests, continuously sample the ambient sound field. These microphones, coupled with an analog-to-digital converter (ADC), transform the acoustic signals into digital data for real-time processing. The ANC algorithm, can employ a filtered-x least mean squares (FXLMS) or similar adaptive filtering technique, analyzes the incoming audio data to identify and isolate the target noise frequencies, such as a horn sound. Vehicle horn typically have a frequency of around 500 Hz.

If no targeted noise is detected 230, the method returns to monitoring 220 for the targeted noise. If the targeted noise is detected 230, such as a horn noise, the ANC algorithm can then generate 240 an anti-phase signal, matched in frequency and amplitude but inverted in phase, which is then fed to the vehicle's audio system or dedicated speakers. In some exemplary embodiments, the method 200 can next determine if the residual noise is less than a threshold level 250, such as a user defined sound level for the particular targeted noise. The system's error microphones can continuously monitor the residual noise, providing feedback to the algorithm for iterative refinement and optimization, ensuring effective noise cancellation across varying driving conditions. This closed-loop system allows for dynamic adaptation to changing noise profiles and ensures consistent noise reduction within the vehicle cabin. If the residual noise level is less than the threshold 250, the method 200 can return to monitoring for the targeted noise 220. If the residual noise level is greater than the threshold level 250, the method can then adjust 260 the phase, frequency and/or amplitude of the anti-phase signal in order to reduce the residual noise level. The method then returns to monitoring 220 for the targeted noise.

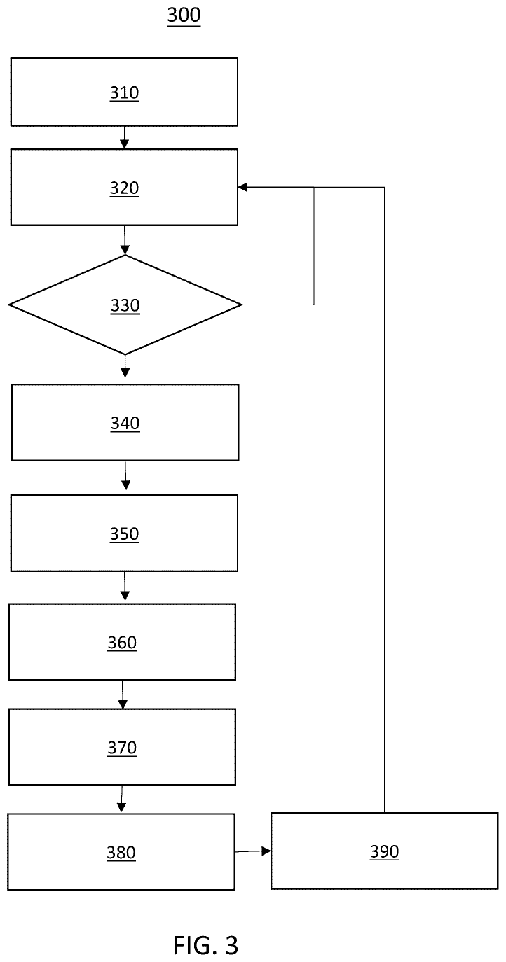

Turning now to FIG. 3, a flow chart illustrating an exemplary implementation of a method 300 for providing cancellation techniques for acoustic interference cancellation in a bidirectional vehicle communications system according to an exemplary embodiment is shown. The exemplary method is first operative to activate the active noise cancellation (ANC) algorithm 310. In some exemplary embodiments, the ANC algorithm can be activated in response to a user input, such as a selection on a user interface, or a transition of a vehicle run state from standby to run or the like. In some exemplary embodiments, the ANC algorithm can receive data indicative of seating position occupancy, such as seat pressure sensors, in-cabin motion detectors, active child restrain device installation or the like. In response to the seating position occupancy, the ANC system can then configure the ANC algorithm such that undesirable noise, such as horn noise or the like, is attenuated at particular seating locations and less attenuated at a driver seating position. For example, the ANC algorithm may determine a child restraint device, such as a baby seat, is installed in a left rear seating position. The ANC algorithm can then monitor for vehicle horn audio frequencies and generate destructive horn frequency audio using the vehicle cabin audio system, at the left rear seating position and can generate constructive horn frequency audio at the driver seating position.

The method 300 is next operative to monitor for both external and internal horn sounds 320 by employing a multi-microphone array and signal processing techniques. External horn sounds, originating outside the vehicle, can be captured by microphones strategically placed on the vehicle's exterior, such as in the side mirrors or near the grille. Internal horn sounds, originating from within the cabin, are detected by microphones located within the vehicle cabin, such as in the headliner, dashboard, or near the rearview mirror. The captured audio signals are then fed into a Digital Signal Processor (DSP) where frequency analysis and pattern recognition algorithms are applied. These algorithms are configured to identify the characteristic frequency range and temporal patterns associated with horn sounds, distinguishing them from other ambient noises. In some exemplary embodiments, the internal horn sound can be detected in response to a horn button push on the steering wheel or the like. In these examples, the active noise cancellation sound can be immediately generated in response to the horn button push as the internal horn frequency and temporal patterns are known.

In response to monitoring 320 for the horn sound, the method 300 determines if a horn sound is detected 330. If no horn sound is detected, the method 300 returns to monitoring 320 for the horn sound. If a horn sound is detected 330, the method 300 next generates a gain vector calculation 340 for the horn sound. The gain vector is a component that dictates the amplitude and phase of the anti-noise signal generated to counteract unwanted noise according to the equation as follows.

$$k ( n ) = \frac{P ( n - 1 ) \cdot x ( n )}{λ + {x}^{T} ( n ) \cdot P ( n - 1 ) \cdot x ( n )}$$

k(n): This is the gain vector at time n. It's a vector that scales the input signal x(n) and is used to update the filter coefficients in the RLS algorithm. It determines how much influence the current input has on the filter's adaptation.
P(n−1): This is the inverse correlation matrix (also known as the covariance matrix) at time n−1. It's a square matrix that represents the inverse of the correlation matrix of the input signal x(n). It plays a crucial role in providing fast convergence. It also helps in decorrelating the input signal components.
x(n): This is the input signal vector at time n. It contains the current input samples used for filtering and adaptation.
x^{T}(n): This is the transpose of the input signal vector x(n).
λ: This is the forgetting factor, a scalar value typically between 0 and 1. The forgetting factor controls the memory of the algorithm, weighting recent data more heavily than older data. A value close to 1 gives the algorithm a long memory, while a value closer to 0 makes it adapt quickly to changes in the input signal.

The gain vector equation is employed to calculate the gain vector k(n) based on the previous inverse correlation matrix P(n−1), the current input signal x(n), and the forgetting factor λ. The numerator P(n−1)*x(n) represents the contribution of the input signal to the gain vector, weighted by the inverse correlation matrix. The denominator λ+x^{T}(n)*P(n−1)*x(n) normalizes the gain vector. The term x^{T}(n)*P(n−1)*x(n) is a scalar value related to the power of the input signal, and adding λ ensures stability and avoids division by zero. The gain vector equation updates the gain vector k(n) in a way that minimizes the error between the desired output and the actual output of the adaptive filter, taking into account the past input signal statistics (through P(n−1)) and the forgetting factor λ. The recursive least squares (RLS) algorithm, using this gain vector calculation, has a fast convergence rate and ability to handle non-stationary signals, making it suitable for applications where the signal characteristics change over time. In response to the calculated gain vector, the method 300 next generates 350 a destructive, or opposite phase, audio signal. The destructive audio signal can be generated by the vehicle cabin audio system via the system speakers. The method 300 next monitors residual noise in the vehicle cabin, or at the intended seating location, using in cabin microphones in order to generate an error signal 360.

In response to the error signal, the method 300 next determines the filter coefficients 370 for the ANC adaptive filtering algorithm, such as the Filtered-X Least Mean Squares (FXLMS) algorithm, in order to iteratively adjust the gain vector to minimize the error signal. The FXLMS algorithm updates the filter coefficients w(n) iteratively to minimize the error e(n) between the desired signal d(n) and the estimated output y(n) according to the equations as follows.

w(n)=w(n−1)+k(n)·e(n)y(n)=w^{T}(n)·z(n)

The output y(n) is calculated by convolving the filter coefficients w(n) with the input signal x(n). The error e(n) is then used to adjust the filter coefficients w(n) in the next iteration. This adjustment is performed by adding a scaled version of the error e(n) to the previous coefficients w(n−1). The scaling factor is the gain vector k(n), which is calculated based on the input signal and the system's dynamics, ensuring that the filter coefficients converge towards the optimal values that minimize the error, effectively generating the counteracting signal necessary for noise cancellation.

In some exemplary embodiments, the FXLMS algorithm can employ a gradient descent approach, where the covariance matrix 380, or gain vector, is updated in each iteration based on the correlation between the filtered reference signal, the noise signal filtered by the secondary path estimate, and the error signal. The update rule can involve multiplying the error signal with the filtered reference signal and a step-size parameter, which controls the convergence rate and stability of the algorithm. The covariance matrix P(n) is updated according to the following.

$$P ( n ) = \frac{1}{λ} [ P ( n - 1 ) - k ( n ) \cdot {x}^{T} ( n ) \cdot P ( n - 1 ) ]$$

The covariance matrix P(n) in an RLS algorithm can be updated iteratively to incorporate new data and ensure the filter's adaptability. The update equation leverages the previous covariance matrix P(n−1), the gain vector k(n), and the input signal vector x^{T}(n). The term k(n)*x^{T}(n)*P(n−1) represents the contribution of the new data to the covariance matrix update. The forgetting factor λ scales the entire update, prioritizing recent data; a smaller λ emphasizes newer information, allowing the system to rapidly adjust to changing noise environments. This continuous update of P(n) ensures that the RLS filter effectively learns from incoming data, maintaining optimal performance in dynamic acoustic conditions. After the covariance matrix is updated 380, the method 300 returns to monitoring for the horn sound 320. This iterative process can continue until the error signal is minimized, resulting in an optimized gain vector that effectively cancels the target noise. The method 300 next updates the destructive audio signal 390 in response to the updated covariance matrix and couples this updated destructive audio signal to a plurality of speakers within the vehicle cabin.

In some exemplary embodiments, the calculation of the gain vector can be further refined by considering the secondary path, which represents the acoustic transfer function from the speakers, or other secondary source, to the cabin microphones. This path can be modeled using a Finite Impulse Response (FIR) filter, which is estimated during an offline or online system identification process. The secondary path estimate is crucial for compensating for the delay and distortion introduced by the acoustic path, ensuring accurate anti-noise signal generation. The gain vector is then used to generate the anti-noise signal by convolving it with the reference noise signal. This anti-noise signal is subsequently played through the speakers, resulting in destructive interference with the unwanted noise. The adaptive nature of the gain vector calculation allows the ANC system to dynamically adjust to changing noise conditions and acoustic environments, ensuring optimal noise reduction performance.

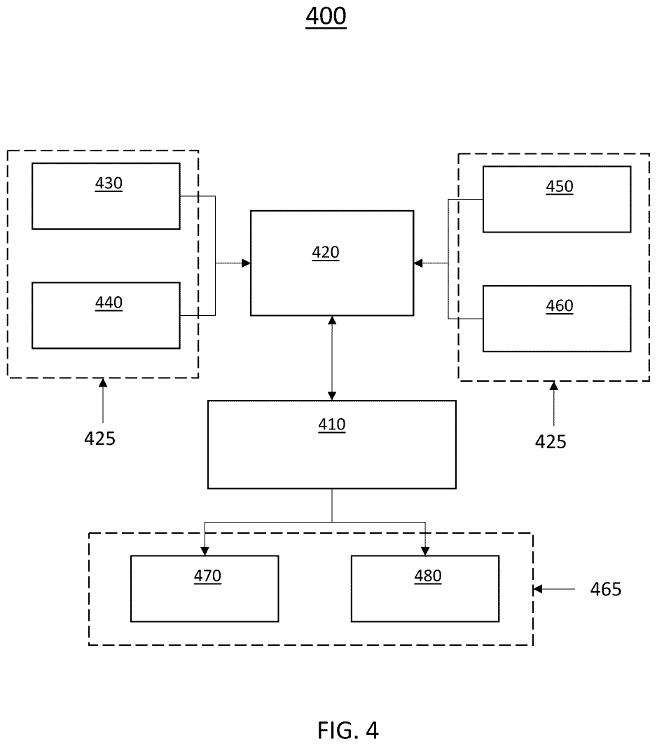

Turning now to FIG. 4, a block diagram illustrating another exemplary implementation of an active noise cancellation (ANC) system 400 according to an exemplary embodiment, is shown. The ANC system 400 can employ a multi-microphone array 425, comprising both interior microphones 430, 440 and exterior microphones 450, 460, to achieve adaptive noise attenuation within a vehicle. The interior microphone array 430, 440, can be strategically distributed throughout the passenger cabin, in order to capture the composite acoustic field which includes the desired audio signal and the residual noise. The exterior microphone array 450, 460 can capture external audio signals, originating from sources such as vehicle horns or other traffic noises. A signal processor 420, utilizing a computationally efficient algorithm, such as the Filtered-X Least Mean Squares (FxLMS) algorithm, can be employed to determine a gain vector based on the amplitude, frequency and phase of the audio signal. This gain vector is then used to generate a primary destructive audio signal, which can subsequently transmitted to a communications processor 410 integral to a vehicle infotainment system or the like. The communications processor 410 can then process the primary destructive audio signal and couple it to a plurality of electroacoustic transducers 465, or speakers 465, located within the vehicle cabin. The plurality of electroacoustic transducers 465, can include a first speaker 470 located near a driver and a second speaker 480 located near a vehicle passenger.

In some exemplary embodiments, the electroacoustic transducers 465 can be configured to radiate the primary destructive audio signal into the vehicle cabin, aiming to create a destructive interference pattern with the original audio signal, thereby minimizing the overall acoustic field. However, due to inherent system nonlinearities, acoustic path variations, and the presence of unmodeled noise sources, residual noise may persist. To address this, the signal processor 420 can employ an adaptive filter, characterized by filter coefficients, to model the secondary path transfer function representing the acoustic path from the speakers 465 to the interior microphones 430, 440. The filter coefficients can be updated iteratively based on the residual noise using an adaptive algorithm, such as the Normalized Least Mean Squares (NLM S) algorithm.

The updated filter coefficients can then be used to generate a secondary destructive audio signal which is then transmitted to the electroacoustic transducers 465. This secondary destructive audio signal can be used to refine the noise cancellation process by compensating for the imperfections and nonlinearities of the system. The iterative process of generating and updating the filter coefficients based on the residual noise allows for a highly adaptive and robust noise cancellation system. The interior microphones 430, 440 which can include two or more microphones, provide a spatially distributed representation of the residual noise, enabling the system to minimize the acoustic field across the entire passenger cabin.

In specific embodiments, the audio signal can originate from a vehicle horn, and the ANC algorithm is triggered by the activation of the horn button. The signal processor 420 can be further configured to determine seating occupancy at various locations within the cabin using ultrasonic or infrared sensors. Based on the seating occupancy data, the system 400 can selectively attenuate the audio signal at specific seating locations while enhancing it at the driver's location, optimizing the acoustic environment for different occupants. Furthermore, the signal processor 420 can be configured to detect the presence of a child restraint system (CRS) at a specific seating location using weight sensors or image recognition algorithms. Upon detecting a CRS, the system 400 can attenuate the audio signal at that location to protect the child's hearing, prioritizing safety. The system 400 can also incorporate a covariance matrix update mechanism, employing an expectation operator and a Hermitian transpose. This covariance matrix, computed from the residual noise and the filter coefficients, can provide a statistical representation of the residual noise and improves the convergence and stability of the adaptive filter.

In alternative embodiments, the exterior microphones 450, 460, positioned outside the vehicle cabin, are utilized to capture external audio signals originating from other vehicles. The phase and amplitude of the residual signal can be determined from the spatially distributed representations captured by the interior microphone array, enabling the system to estimate the acoustic path transfer function and generate the filter coefficients with high accuracy. The system is also applicable to scenarios where the audio signal originates from the vehicle's own horn, with the interior microphones 430, 440 array providing the necessary feedback for the ANC algorithm. The system 400 can to adapt to varying acoustic environments and noise sources to ensure optimal noise cancellation performance across a wide range of operating conditions.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An active noise cancellation system comprising:
a microphone array configured to receive an audio signal and a residual noise;
a signal processor configured to determine a gain vector in response to an amplitude, a frequency and a phase of the audio signal, to generate a first destructive audio signal in response to the gain vector and the audio signal, and to couple the first destructive audio signal to a plurality of speakers within a vehicle cabin; and
the plurality of speakers configured to radiate the first destructive audio signal into the vehicle cabin, the signal processor being further operative to generate a filter coefficient in response to the residual noise, wherein the residual noise results from a combination of the audio signal and the first destructive audio signal within the vehicle cabin, to generate a second destructive audio signal in response to the filter coefficient and the first destructive audio signal, and to couple the second destructive audio signal to the plurality of speakers, wherein the plurality of speakers are configured to radiate the second destructive audio signal into the vehicle cabin.

2. The active noise cancellation system of claim 1, wherein the microphone array includes a plurality of microphones distributed throughout a vehicle passenger cabin.

3. The active noise cancellation system of claim 1, wherein the audio signal is generated by a vehicle horn and wherein an active noise cancellation algorithm is activated in response to a depression of a vehicle horn button.

4. The active noise cancellation system of claim 1, wherein the signal processor is further configured for determining a seating occupancy at a seating location and wherein the first destructive audio signal is generated to attenuate the audio signal at the seating location and to enhance the audio signal at a driver seating location.

5. The active noise cancellation system of claim 1, wherein the signal processor is further configured for detecting a child restrain device in a seating location and wherein the first destructive audio signal is generated to attenuate the audio signal at the seating location.

6. The active noise cancellation system of claim 1, wherein the signal processor is further configured for updating a covariance matrix in response to the filter coefficient and the residual noise and generating the second destructive audio signal in response to the covariance matrix.

7. The active noise cancellation system of claim 1, wherein the microphone array is located outside of the vehicle cabin and wherein the audio signal originates from another vehicle.

8. The active noise cancellation system of claim 1, wherein the microphone array is distributed throughout the vehicle cabin and wherein a residual noise phase and a residual noise amplitude are determined in response to a plurality of representations of the residual noise received at the microphone array and wherein the filter coefficient is generated in response to the residual noise phase and the residual noise amplitude.

9. The active noise cancellation system of claim 1, wherein the microphone array is located within the vehicle cabin and wherein the audio signal originates from a horn of a host vehicle.

10. A method for performing active noise cancellation within a vehicle cabin comprising:
receiving, via a microphone array, an incoming acoustic signal including an audio signal;
determining, by a processor, a gain vector in response to an amplitude, a frequency and a phase of the audio signal;
generating, by a communications processor, a first destructive audio signal in response to the gain vector;
coupling the first destructive audio signal to a plurality of speakers located within the vehicle cabin;
detecting, with a microphone within the vehicle cabin, a residual noise, wherein the residual noise results from a combination of the audio signal and the first destructive audio signal within the vehicle cabin;
generating, by the processor, a filter coefficient in response to the residual noise;
generating, by the communications processor, a second destructive audio signal in response to the filter coefficient and the first destructive audio signal; and
coupling the second destructive audio signal to the plurality of speakers located within the vehicle cabin.

11. The method for performing active noise cancellation within the vehicle cabin of claim 10, wherein the microphone array includes a plurality of microphones within a vehicle passenger cabin.

12. The method for performing active noise cancellation within the vehicle cabin of claim 10, wherein the audio signal is generated by a vehicle horn and wherein an active noise cancellation algorithm is activated in response to a depression of a vehicle horn button.

13. The method for performing active noise cancellation within the vehicle cabin of claim 10, including determining a seating occupancy at a seating location and wherein the first destructive audio signal is generated to attenuate the audio signal at the seating location and to enhance the audio signal at a driver seating location.

14. The method for performing active noise cancellation within the vehicle cabin of claim 10, including detecting a child restrain device installed in a seating location and wherein the first destructive audio signal is generated to attenuate the audio signal at the seating location.

15. The method for performing active noise cancellation within the vehicle cabin of claim 10, further including updating a covariance matrix in response to the filter coefficient and the residual noise and generating the second destructive audio signal in response to the covariance matrix.

16. The method for performing active noise cancellation within the vehicle cabin of claim 10, wherein the microphone array is mechanically coupled to a host vehicle outside of the vehicle cabin and wherein the first destructive audio signal originates from another vehicle.

17. The method for performing active noise cancellation within the vehicle cabin of claim 10, wherein the microphone within the vehicle cabin includes a plurality of microphones distributed throughout the vehicle cabin and wherein a residual noise phase and a residual noise amplitude are determined in response to a plurality of representations of the residual noise received at the microphone array and wherein the filter coefficient is generated in response to the residual noise phase and the residual noise amplitude.

18. The method for performing active noise cancellation within the vehicle cabin of claim 10, wherein the microphone array is located within the vehicle cabin and wherein the first destructive audio signal originates from a horn of a host vehicle.

19. An active noise cancellation system within a vehicle cabin comprising:
a first plurality of microphones located within the vehicle cabin for receiving an acoustic signal and for generating a first data representative of the acoustic signal received at the first plurality of microphones, wherein the first data is representative of a first gain, a first phase and a first amplitude of the acoustic signal received at the first plurality of microphones;
a second plurality of microphones located external to the vehicle cabin for generating a second data representative of the acoustic signal received at the second plurality of microphones, wherein the second data is representative of a second gain, a second phase, and a second amplitude of the acoustic signal received at the second plurality of microphones;
a processor for determining a gain vector in response to the first phase, the second phase, the first amplitude, and the second amplitude, for determining generating a destructive audio signal in response to the gain vector;
a communications processor for coupling the destructive audio signal to a plurality of speakers within the vehicle cabin such that the acoustic signal is attenuated within the vehicle cabin.

20. The active noise cancellation system within the vehicle cabin of claim 19, further including:
a user interface operative to receive a user input and wherein an active noise cancellation algorithm is initiated in response to the user input; and
a seating occupancy sensor configured to detect an occupant in a seating location, and wherein the communications processor is further operative to focus the destructive audio signal at the seating location such that the acoustic signal is attenuated at the seating location and the acoustic signal is not attenuated at a driver seating location.
